(19) United States
(12) Patent Application Publication
(10) Pub. No.: US 2008/0267633 A1
(43) Pub. Date: Oct. 30, 2008

(54) SPLIT EQUALIZATION FUNCTION FOR OPTICAL AND ELECTRICAL MODULES

(75) Inventors: Jan Peeters Weem, Fremont, CA (US); Tom Mader, Los Gatos, CA (US); Fulvio Spagna, San Jose, CA (US)

Correspondence Address: COOL PATENT, P.C.;c/o INTELLEVATE, P.O. BOX 52050, MINNEAPOLIS, MN, 55402, US

(73) Assignee: INTEL CORPORATION, Santa Clara, CA (US)

(21) Appl. No.: 11/740,505

(22) Filed: Apr. 26, 2007

(51) Int. Cl. H04B 10/00

(52) U.S. Cl. 398/116

(57) ABSTRACT

Briefly, in accordance with one or more embodiments, optical transceiver module includes a first equalizer disposed internal to the optical transceiver module that is capable of equalizing an electrical signal provided to a host board in combination with a second equalizer disposed on the host board in a split equalization type arrangement.

### BACKGROUND

Equalizers may be utilized in optical and electrical type systems for example to correct for any channel impairments in the channel or for electronic dispersion compensation (EDC). Typically, such equalizers may be utilized on host boards that include one or more optical transceiver modules that convert signals between optical signals and electrical signals.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a block diagram of an optical transceiver in accordance with one or more embodiments; and

FIG. 2 is a block diagram of host board having an optical transceiver illustrating a first equalizer in the optical transceiver module and a second equalizer on the host board in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

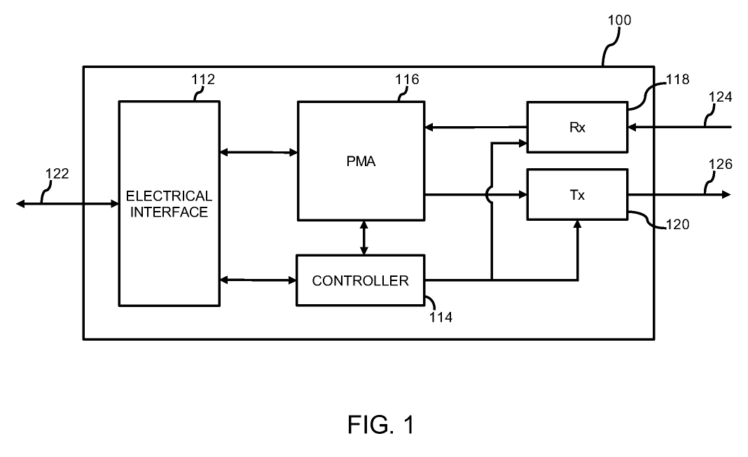

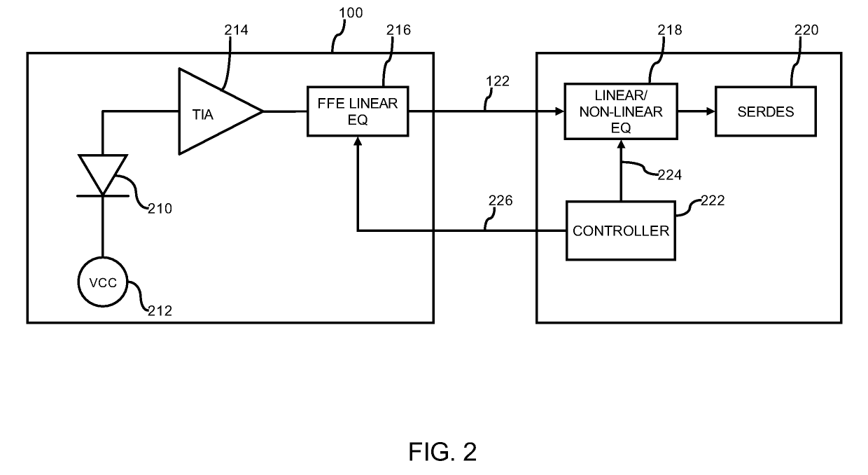

Referring now to FIG. 1, a block diagram of an optical transceiver in accordance with one or more embodiments will be discussed. As shown in FIG. 1, optical transceiver module 100 may comprise electrical interface 112, controller 114, physical medium attachment (PMA) 116, receiver 118, and transmitter 120. Such an optical transceiver module 100 may be provided in various form factors, for example an small form-factor pluggable (SFP) or SFP+ type form factor, a XENPAK type form factor, or the like. In one or more embodiments, optical transceiver module is capable of operating at speeds on the order of 8 gigabits per second or 10 gigabits per second, although the scope of the claimed subject matter is not limited in these respects. Electrical interface 112 may provide input/output data transfer to a host card for example host card 200 of FIG. 2 via electrical signal path 122, clocking channels, control and monitoring channels, and/or direct-current (DC) power and ground connections. Electrical interface 112 interface may take the form of a socket that plugs in to a host board, or may comprise a board-edge connect that mates to a socket in the plane of the host board, for example to provide front panel pluggability into the host board. In addition, electrical interface may provide hot-pluggability and inrush current management, although the scope of the claimed subject matter is not limited in these respects.

Electrical interface 112 may have a data bus where the width of the data bus varies depending on the type of form factor and/or Multi-Source Agreement (MSA) for which optical transceiver module 100 is intended. For example, the data bus may comprise a 1-bit differential bus, a 4-bit differential bus, a 16-bit differential bus, and so on. Electrical interface 112 may also provides direct-current (DC) connections to the DC power supplies of the host board.

In one or more embodiments, controller 114 may implement a control system for optical transceiver module 100. Controller 114 may perform multiple functions that previously had been implemented using analog hardware. Controller 114 may set control parameters for the Physical Medium Attachment (PMA) 116, receiver (RX) 118 and/or transmitter (TX) 120, which may include operational parameters that may vary over time and/or temperature and/or when the host system changes the link configuration, for example loopback modes. In one or more embodiments, controller 114 may also provide a two-wire interface such as I2C so the host board can set control parameters and read the status registers where monitor values are stored, although the scope of the claimed subject matter is not limited in these respects.

Physical medium attachment (PMA) 116 may provide core electrical functionality for optical transceiver module 100, for example to maintain robust signal integrity at higher data rates. In one or more embodiments, PMA 116 may include a clock multiplier/multiplexer (MUX/CMU) circuit and clock and data recovery/demultiplexer (CDR/DEMUX) circuit. The MUX/CMU circuit interleaves the 16-channel data bus into a serialized data stream at the line rate, clocked by a multiplied version of the input clock. This data stream is used to modulate transmitter 120. The CDR/DEMUX circuit provides the complementary functionality on the receive side for receiver 118.

In one or more embodiments, receiver 118 may comprise a device capable of converting an incoming optical signal 124 into an electrical signal. Likewise, transmitter 120 may comprise a device capable of converting an electrical signal into an outgoing optical signal 126. The type of devices utilized for receiver 118 and transmitter 120 may depend upon the reach requirements of the fiber link for the optical signals. For example, for Very Short Reach (VSR) applications in the enterprise space, such as within-building or within-campus a gallium arsenide/aluminum gallium arsenide (GaAs/AlGaAs) type Vertical Cavity Surface Emitting Laser (VCSEL) may be utilized as the optoelectronic device for transmitter 120. For receiver 118, a GaAs type positive-intrinsic-negative (PIN) photodetector may be utilized. For Longer Reach (LR) links on the order of about 7-20 kilometers, transmitter 120 may include an indium phosphide (InP) based single-mode Distributed Feedback Laser (DFB) operating for example at 1310 nm. For metro area network access, extended reach (ER) links on the order of about 40-80 kilometers may be utilized. In such embodiments, a DFB laser combined with an Electro-Absorption Modulator (EAM) on an InP substrate may be utilized. Receiver 118 may include an InP type device or gallium arsenide (GaAs) PIN type photodiodes, or an InP Avalanche Photodiodes (APD) type device, to convert light into electrical current, for example. However, these are merely examples of optical-electrical devices that may be utilized for receiver 118 or transmitter 120, and the scope of the claimed subject matter is not limited in these respects.

Referring now to FIG. 2, a block diagram of host board having an optical transceiver illustrating a first equalizer in the optical transceiver module and a second equalizer on the host board in accordance with one or more embodiments will be discussed. As shown in FIG. 2, optical transceiver module 100 may be plugged into host board 200. In one or more embodiments, optical transceiver module 100 may comprise a PIN type photodiode 210 coupled to a rail voltage (VCC) 212 at the cathode of PIN photodiode 210. The anode of PIN photodiode 210 may couple to an input of transimpedance amplifier (TIA) 214, which may comprise a linear type transimpedance amplifier. Transimpedance amplifier 214 may operate to convert photocurrent passing through PIN photodiode 210 into a voltage signal, although the scope of the claimed subject matter is not limited in these respects.

In one or more embodiments, optical transceiver module 100 may include a feed forward equalizer (FFE) type linear equalizer 216 that couples with a linear and non-linear equalizer 218 disposed on host board 218. In such an arrangement, part of the equalization for electrical signal path 212 may be performed on optical transceiver module 100 by FFE linear equalizer 216, and part of the equalization for electrical signal path 122 may be performed on host board 200 by linear and non-linear equalizer 218. Such an arrangement may be generally referred to as a split equalization arrangement, however the scope of the claimed subject matter is not limited in this respect. In one or more embodiments, FFE linear equalizer 216 may comprise a non-retimed type filter, and linear and non-linear equalizer 218 may comprise a re-timed decision feedback type filter. FFE linear equalizer 216 may work in unison with linear and non-linear equalizer 218, and may be fully and/or at least partially controlled by instructions executed by controller 222, which may be disposed on host board 200, via control lines 224 and 226. As a result, linear and non-linear equalizer 218 is not required to be a full equalizer and/or not required to perform all of the equalization for electrical signal path 122. For example, a full long reach standard for multimode fiber (LRM) type equalizer operating at multiple ports of host board 200 may not be required for host board 200 in one or more embodiments. By disposing FFE linear equalizer 216 only in modules that may require additional equalization, for example for a 10G-LRM type link, linear and non-linear equalizer 218 on host board may be realized via simpler and less complex equalizers, while allowing for more complex equalization one channels that may benefit from higher equalization by utilization of two equalizers in a split equalization arrangement as shown in FIG. 2 where a first equalizer, such as FFE linear equalizer 216, may be disposed on optical transceiver module 100 and a second equalizer, such as linear and non-linear equalizer 218, may be disposed on host board 200 to provide combined equalization of via the first equalizer and the second equalizer. It should be noted that the split equalization arrangement may be provided in various alternative arrangements with a varying split of equalization between optical transceiver module 100 and host board 200, and that furthermore the types of equalizers shown in FIG. 2 are merely example types of equalizers, wherein other types of equalizers may be used that may be different that shown in FIG. 2, and the scope of the claimed subject matter is not limited in these respects. The output of linear and non-linear equalizer 218 may be provided to serializer/deserialzier (SERDES) 220 disposed on host board 200 to convert data between serial data and parallel data.

In one or more embodiments, host board 200 may comprise a device capable of utilizing optical transceiver module 100 to communicate vial optical signals such as utilized in various telecommunications and/or networking type applications. For example, host board 200 may comprise a backplane for example as part of a server, a switch line card, an Ethernet or Gigabit Ethernet type card, or as part of a storage area network (SAN) for example a Fibre channel type system or the like. Furthermore, host board 200 may comprise a broadband wireless network type baseband board or the like for example for a Worldwide Interoperability for Microwave Access (WiMAX) type network. However, these are merely examples for host card 200, and the scope of the claimed subject matter is not limited in these respects.

Although the claimed subject matter has been described with a certain degree of particularity, it should be recognized that elements thereof may be altered by persons skilled in the art without departing from the spirit and/or scope of claimed subject matter. It is believed that the subject matter pertaining to split equalization function for optical and electrical modules and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. An optical transceiver module, comprising:
an optoelectronic device;
a transimpedance amplifier coupled to the optoelectronic device to convert a current flowing through the optoelectronic device into an electrical signal; and
an equalizer capable of receiving an output of the transimpedance amplifier to provide equalization of the electrical signal.

2. An optical transceiver module as claimed in claim 1, the optoelectronic device comprising a positive-intrinsic-negative photodiode.

3. An optical transceiver module as claimed in claim 1, the transimpedance amplifier comprising a linear type amplifier.

4. An optical transceiver module as claimed in claim 1, the equalizer comprising a feed forward type equalizer.

5. An optical transceiver module as claimed in claim 1, the equalizer comprising a linear type equalizer.

6. An optical transceiver module as claimed in claim 1, the equalizer comprising a feed forward linear equalizer.

7. An optical transceiver module as claimed in claim 1, the equalizer being capable of equalizing the electrical signal in combination with an equalizer disposed on a host board.

8. A host board, comprising:
an optical transceiver module, the optical transceiver module comprising a first equalizer disposed internal to the optical transceiver module; and
a second equalizer disposed on the host board external to the optical transceiver module;
wherein the first equalizer is capable of equalizing an electrical signal provided to the host board by the optical transceiver module in combination with the equalizer disposed on a host board.

9. A host board as claimed in claim 8, the optical transceiver module comprising an optoelectronic device comprising a positive-intrinsic-negative photodiode.

10. A host board as claimed in claim 8, the optical transceiver module comprising a transimpedance amplifier comprising a linear type amplifier.

11. A host board as claimed in claim 8, the first equalizer comprising a feed forward type equalizer.

12. A host board as claimed in claim 8, the first equalizer comprising a linear type equalizer.

13. A host board as claimed in claim 8, the first equalizer comprising a feed forward linear equalizer.

14. A host board as claimed in claim 8, the second equalizer comprising a linear equalizer, a non-linear equalizer, or combinations thereof.

15. A host board as claimed in claim 8, wherein the optical module is compliant with a long reach standard for multimode fiber.
